(19) United States
(12) Patent Application Publication
(10) Pub. No.: US 2015/0368960 A1
(43) Pub. Date: Dec. 24, 2015

(54) MODULAR WINDOW VENTILATION SYSTEM

(71) Applicants: CLIMAWIN TECHNIQ APS, Lunderskov (DK); RAUH SR FENSTERBAU GMBH, Zapfendorf / Sassendorf (DE); SOLEARTH ECO-LOGICAL ARCHITECTURE, Dublin (IE)

(72) Inventor: Poul Christensen Horn, Lunderskov (DK)

(73) Assignees: ClimaWin Techniq ApS, Lunderskov (DK); Solearth Ecological Architecture, Dublin (IE); Rauh SR Fensterbau GmbH, Zapfendorf/Sassendorf (DE)

(21) Appl. No.: 14/650,072

(22) PCT Filed: Dec. 4, 2013
(86) PCT No.: PCT/DK2013/050411

§ 371 Date: Jun. 5, 2015

(30) Foreign Application Priority Data
Dec. 5, 2012 (DK) PA 2012 70759

(51) Int. Cl. E06B 7/10; F24F 13/18

(52) U.S. Cl. CPC E06B 7/10; F24F 13/18

(57) ABSTRACT

The invention relates to a ventilation device for a window, having at least two essentially parallel panes of glass arranged in a common frame, thus forming a double window having an air space between the panes of glass, and an intake opening communicating with the air space and with either the interior or the exterior of a building, where the ventilation device also has a drive unit. Such a ventilation device has at least one air direction control unit arranged in connection with the window and where the air direction control unit (10) has a body, having a first throttle and a second throttle, and a device for operating the throttles between an open and a closed position. The body also has an opening communicating with the interior of said building, an opening communicating with the exterior of the building and a third opening communicating with the air space.

### BACKGROUND OF THE INVENTION

1. Field of the Invention

The present invention relates to a ventilation device for ventilating a room in a building, said building comprising a window, said window comprising at least two essentially parallel panes of glass, said at least two panes of glass being arranged in a common frame, casement or sash, hereinafter referred to as a frame, or in two or more juxtaposed and preferably connected frames, thus forming said window, e.g., a double window, where said at least two panes of glass are arranged with a distance, and thus appear with an air space between said panes of glass, said window further comprising an intake opening communicating with said air space and with either the interior or the exterior of said building, where said ventilation device further comprises a drive unit.

2. Description of Related Art

The invention further relates to a window for a building comprising a ventilation device where said ventilation device is arranged in a window frame, casement or sash, and even further to a method for operating a ventilation device for ventilating a room in a building.

It is well known to have window constructions that in some manner are arranged together with ventilation systems that allow air to be circulated from the outside to the inside of a room or building, by guiding the air between two panes of glass and into the inside. This is done to ventilate the room or building with air that is preheated during its flow between the two panes of glass. Over the years it has been common to regulate such a flow by manually opening and closing shutters or sliding doors at the bottom and at the top of a window frame. This is, however, dependent of an operator actually operating the mentioned shutters or sliding doors and as it is a manual process, an optimum operation is practically impossible to obtain.

In order to have a more controlled system various complex solutions have been presented. European Patent EP 1 809 848 B1 and corresponding to U.S. Pat. No. 8,221,201 B2 describe a solution comprising a rather complicated cartridge consisting of no less than four slide throttles, two thermo-hydraulic actuators, and two chambers. This cartridge is suitable for arranging in the top member of a window frame and is controlled solely by said thermo-hydraulic actuators which are connected to said slide throttles. As mentioned before, this is a rather complex solution and the cartridge is quite complicated and thus also expensive. Furthermore, there is only one way of controlling this system, namely via said thermo-hydraulic actuators which sense or react according to the temperature at the position of the cartridge—actually inside the cartridge. The system is thus not very reactive and rather large fluctuations in temperature between the panes of glass, outside or inside the building can occur without the system even responding.

European Patent Application EP 1486637 A2 also describes a ventilation device which is built into a window frame, which is incorporated into a double glassed window. A fan forces air from one of the openings in the bottom of the window frame, up through the channel between the two window panes and out through to one of the openings in the top of the window. The air inlet/outlet openings are operated by sliding shutters, which may be operated by a motor. This construction is very complex as it needs one or more fans as well as motor driven sliding shutters, at least for the outdoor openings in the top and bottom of the window frame, in order to provide the ventilation of the room behind the window.

From German Patent Application DE 30 43 783 A1 another system is known that also is rather complex. This system comprises two units—one in the lower and one in the upper window frame. Both of these units may be operated individually and manually between four different positions on each unit. Said units can be mechanically connected by e.g., a chain or belt connection that has to be built into the window frame, thus allowing both units to be operated by one manual control means. Further, the units in this system are constructed with an outer cylindrical tube with a number of holes in the periphery that interact with corresponding holes or bores in a central inner cylindrical regulating member installed inside said tube. By rotating the inner part of the two units, in relation to the outer part, air can be directed into various directions. A solution as this also has the drawback of being rather high and thus demanding a rather high window frame, which will “steal” relatively much of the regular window area and thus allow less light to enter the building.

As can be understood from the above, these known solutions are somewhat complex, expensive to build and install in window constructions, and they are not very easy to operate and to control in a manner that allows good and efficient use of the ventilating system, which when taken seriously can contribute quite a bit to a better environment in the building and at the same time save cost for heating and/or cooling when used in a proper way.

### SUMMARY OF THE INVENTION

It is an object of the invention to provide a ventilation system/device for installation in a window frame, casement or sash, where the ventilation unit is simple, robust and effective. Further, it is an object of the invention to provide a shallow and modular ventilation system that can be built into a window without said window having to have an architectural appearance that differs essentially from the traditional appearance. Such a window can be, e.g., a new double-window construction in a building worthy of preservation, where the original architectural appearance is important.

As mentioned above, the invention relates to a ventilation device for ventilating a room in a building, said building comprising a window, said window comprising at least two essentially parallel panes of glass, said at least two panes of glass being arranged in a common frame, casement or sash, hereinafter referred to as a frame, or in two or more juxtaposed and preferably connected frames, thus forming said window, e.g., a double window, where said at least two panes of glass are arranged with a distance, and thus appear with an air space between said panes of glass, said window further comprising an intake opening communicating with said air space and with either the interior or the exterior of said building, where said ventilation device further comprises a drive unit.

A ventilation device according to the invention comprises at least one air direction control unit, where said air direction control unit is arranged in connection with said window and where said air direction control unit comprises a body, having a first throttle and a second throttle, said air direction control unit further comprises means for operating said first and second throttle between an open and a closed position, further said body comprises a first opening communicating with the interior of said building, a second opening communicating with the exterior of said building and a third opening communicating with said air space. Said air direction control unit comprises a shaft, where said throttles or throttle are arranged hinged at said shaft. When the relevant throttle is closed, it is resting against a seat in the first and/or in the second opening in said body.

This allows air to be circulated between the panes of glass, as air is led through the intake from one side of the window, and due to natural flow of heated air between the two panes of glass, heated by the sun or the ambient temperature on either side of the panes of glass, this air is guided and led out via the first opening and the first throttle or via the second opening and the second throttle, on either the same side of the window or on the opposite side. Air can be e.g., taken from the exterior, led into the air space, heated up by the sun, and thus, rising and circulating within the air space and led out on the exterior side. This will have a cooling effect on the air in said air space, as it is allowed to circulate and to be exchanged. Further, this will also have a cooling effect on the interior as heat is conducted away from said window.

Another situation can be that air is led into the air space from the exterior, heated and then led into the interior of the building. This will supply fresh and preheated air into the building.

Yet another situation can be that air is led into the air space from the interior, heated and led back into the interior of the building. This situation allows for air inside a room or building to be heated up, as the air is travelling into and out of said air space. In this situation as well as in the first mentioned situation, there is no supply of fresh air to the room or building.

An air direction control unit as described above can be used in windows with two single layer glass panes or with one or two layers of thermo glass panes (double glazing) or with triple glazing in any other possible setup comprising an air space.

Tests have proven that at a 20° C. inside temperature and a 0° C. outside temperature, the sun will heat the air from 0° C. to 10° C. before it enters into the interior of the building, which will prevent the feeling of draught, but still supply fresh air into the building and thus vent the room. Other tests have proven that during a summer day, it is possible to hold the inside temperature up to 12° C. below the outside temperature, due to venting the air space. This is, of course, related to the amount of airflow through the air space.

An air direction control unit as described above can with advantage be manufactured as a modular part that can be put together with one or more modular parts to suit various geographical areas where different needs for ventilation and/or preheating are needed. This is obtained simply by adding more units to an, in principle, limitless row of units.

A further embodiment of an air direction control unit comprises said first and second throttle, and said throttles are arranged in the body of the air direction control unit in a manner that allows the throttles to be closed totally by positioning both throttles in a closed position at the same time.

As each of the throttles is hinged at said shaft free to rotate about said shaft, the throttles are self-closing due to gravity. Such a design makes it possible to design the ventilation unit rather shallow—with a low height—and thus have a solution that can easily be integrated in a window frame without said frame having an essentially different appearance than a frame without such a ventilation unit. This allows for a window that has an architectural appearance that does not differ essentially from an old window with a traditional appearance and with no ventilation device. A window comprising a ventilation device according to the invention can be, e.g., a new double-window construction in a building worthy of preservation where the original architectural appearance is important.

In a preferred embodiment of a ventilation device according to the invention, said ventilation device further comprises a bypass unit, where said bypass unit is arranged in said window and where said bypass unit comprises a body and a throttle, said bypass unit further comprises means for operating said throttle between a closed and an open position, further said body comprises a first opening communicating with the interior of said building, and a second opening communicating with the exterior of said building.

A body for an air direction control unit and for a bypass unit can advantageously be alike. The only difference is that an air direction control unit has a third opening, which can be blocked by a suitable piece, e.g., a piece that clicks right into the opening and closes it. This way the exterior of the units, no matter if it is an air direction control or a bypass unit, is the same, meaning that also the slot or cut out in a window frame can be made with the same dimension for both types of units.

Further, the throttles can also be the same in an air direction control unit as in a bypass unit which makes not only the outside of the units modular, but also the inside parts.

By using both an air direction control unit and a bypass unit, it becomes possible to choose different patterns for ventilation and preheating including the following options:
Heated air can be led from the exterior through the air space and to the interior of the building via the air direction control unit.
Heated air can be led from the exterior through the air space and back to the exterior of the building via the air direction control unit.
Fresh air can be led from the exterior and directly into the interior via the bypass unit.

The air direction control unit and also the bypass unit can be controlled as a function of various conditions, e.g., the outside temperature, the inside temperature, the outside humidity, the inside humidity, the content of CO₂ in the inside air, the content of O₂ in the inside air, UV radiation or other parameters. Said parameters can be taken into account via sensors connected to a control unit, where input from such one or more sensors are computed and transferred into a valid input to control the air direction control and/or bypass units.

In another embodiment of a ventilation device according to the invention, said bypass unit comprises a shaft, where said throttle is arranged hinged at said shaft and resting in a closed manner against a seat in an opening in said body. As the throttles are hinged at said shaft free to rotate about said shaft, the throttles are self-closing due to gravity similarly to the air direction control unit as described above. Such a design makes it possible to design the ventilation unit rather shallow—with a low height—and thus have a solution that can easily be integrated in a window frame without said frame having an essentially different appearance than a frame without such a ventilation unit as already discussed in relation to the air direction control unit as described above.

In a preferred embodiment of the ventilation device according to the invention, said air direction control unit and/or bypass unit further comprises a sealing material arranged between a throttle and a seat for said throttle, and preferably on the throttle. By arranging such a sealing material in an air direction control unit and/or bypass unit, a more tight closure of the throttles is obtained and larger noise reducing from the exterior and from the movement of said throttles is also obtained. The sealing material can be a soft polymer material or a kind of fabric or felt. Said sealing material can be arranged on the full surface of the parts on said throttle that are facing the seat for said throttle, but can also be arranged only in a more local area according to the contact zone between the throttle and the seat.

A ventilation device according to the invention may comprise that said air direction control unit and/or bypass unit each comprise one or two throttles, and further comprises a weight material, e.g., one or more metal plates, arranged on said throttle or throttles. Said weight material can help the respective throttles to be held in a closed position and to bring the throttles in said closed position when they are not activated by any activation means.

In yet a preferred embodiment of a ventilation device according to the invention, said shaft comprises means for connection to a drive unit comprising, e.g., an electric and/or a thermal actuator, said drive unit further comprises or being connected to means for activating said one or more throttles between a closed position and an open position, said means e.g., being one or more cams installed on said shaft, where rotation of said shaft in a specific direction will rotate said cam or cams to push against one or more specific throttles. By installing said units in a row where the units are aligned and with a common hinge line and centerline for throttles and for cams, a number of units/throttles can be operated by a single drive unit that exerts a rotational movement on the shaft/connected shafts and thus moves the cam/cams to push the throttle/throttles.

The throttles can, as mentioned above, comprise hinges that, when installed at said shaft, are forming a hinge line about which all the installed throttles are individually movable between a closed position and an open position. A cam arranged at the shaft at the same hinge line as the throttle or throttles will when said cam is rotated about said hinge line—during rotation of the shaft—act on a throttle by moving said throttle between a closed and an open position. By moving a cam in a first direction, a first throttle may be operated and by moving a cam in a second direction, a second throttle may be operated. When a cam is not pushing or in contact with a throttle, said throttle will due to its hinge be in a closed position and resting against its respective seat.

The cams and the shafts in an air direction control unit and in a bypass unit can advantageously be designed to be identical in order to support the general idea of a system according to the invention being modular and comprising as few different parts as possible.

The shaft of the air direction control unit and the bypass unit can be a common shaft, whereby both units can be operated by a single drive unit, as discussed further below, simply by positioning the cams for throttles in the air direction control unit and the cams for the throttle in the bypass unit at different angles on the common shaft such that the throttles of the air direction control unit are operated when the shaft is rotated in a first angular range. The throttle of the bypass unit can then be operated when the shaft is rotated at a second angular range. When the cam of the bypass unit is arranged on the shaft such that this second angular range is similar to the range in which at least the throttle arranged at the indoor side of the air direction control unit is closed, it is possible to provide independent operation of the throttles in the air direction control unit and the bypass unit via a single common shaft.

Alternatively, the shaft of the air direction control and the bypass units are separate shafts whereby a common drive unit can operate the shafts of air direction control unit and the bypass unit independently.

The control means for operating the shaft and the cams may comprise an electrical actuator, either a rotary actuator or a linear actuator.

The control means can also comprise thermal actuators, e.g., thermal hydraulic actuators of the rotary or linear type. No matter what type of actuator is used, one or more of said actuators may be built into a drive unit, having the same external thickness and width as the air direction control units and/or bypass units. One drive unit comprising one or more actuators can be used for one or for a set of units, no matter if there are one or many units of either type. Further by having the same overall dimensions of the drive unit and the air direction control unit and bypass units, all of these units can be installed in a uniform slot or cut out in a window frame, which makes production more simple as it is only the length of said slot or cut out that has to be adapted.

In another embodiment of a ventilation device according to the invention, said air direction control unit and bypass unit or units comprise an insulating jacket, e.g., a polystyrene or polyurethane jacket, for one or more individual units. Such an insulation jacket can be moulded around each unit and comprise some kind of connecting means at the abutting ends, but it can also be moulded around already connected units. In yet a variant of an insulation jacket, said insulation jacket can be a cover or shell that is arranged around one or more units, said cover or shell having an aperture for the units.

A ventilation device according to the invention may comprise control means for controlling and operating said drive unit, where said control means comprises at least one sensor, e.g., a temperature sensor, a humidity sensor, a CO₂ sensor and/or an O₂ sensor. This will allow the ventilation device, i.e., the drive unit to operate the air direction control unit and the bypass unit or units as a function of temperature, humidity, CO₂ content, O₂ content or other parameters or combinations of such parameters. Input from one or more sensors can be computed in a control system and used as input for one or more electrical actuators in the drive unit. Such a control unit can easily be integrated with e.g., sun shading of one or more windows and can be controlled via various parameters. A ventilation device can, e.g., also comprise photovoltaic elements for power supply to the drive unit and for other electrical features in said device.

In the description of the drawings, an example of how an air direction control unit and/or a bypass unit can be constructed will be seen and discussed and this description will support and explain the description of the above-mentioned embodiments in details.

The invention further comprises a window for a building comprising a ventilation device according to the above description, where said ventilation device is arranged in a window frame, casement or sash.

Further the invention also comprises a method for operating a ventilation device for ventilating a room in a building, according to the above description, where said building comprises a window, said window comprising at least two essentially parallel panes of glass, said at least two panes of glass being arranged in a common frame, casement or sash, hereinafter referred to as a frame, or in two or more juxtaposed and preferably connected frames, thus forming said window, e.g., a double window, where said at least two panes of glass are arranged with a distance, and thus appear with an air space between said panes of glass, said window further comprising an intake opening communicating with said air space and with either the interior or the exterior of said building, where said ventilation device further comprises a drive unit.

The method mentioned above comprises at least the steps of:
detecting and computing input from at least one sensor, said input being based on actual conditions outside or inside said building or in said window or device,
determining by control means, based on said input, whether air should be led from the outside, through the air space and to the inside of the building,
determining by control means, based on said input, whether air should be led from the outside, through the air space and back to the outside of the building,
determining by control means, based on said input, whether air should be led from the outside and directly to the inside of the building or vice versa,
operating one or more throttles according to said input and determination.

By a method as described, it is possible to control the ventilation device in a manner that ventilates according to the specific conditions and according to individual demands and adjustments. The regulation or control can be done fully automatically in a simple and efficient manner, or it can be done by manual input via some kind of suitable input device, e.g., an input device installed in connection with one or more of the above-mentioned sensors. A temperature sensor could for instance comprise a dial or other input means for adjusting and controlling said ventilation device.

A further step of the above mentioned method can be to detect and compute input from at least one sensor, said input being based on actual conditions outside or inside said building or in said window or device, where said input is determined by control means, where it is determined, based on said input, whether air should be led from the inside, through the air space and back to the inside of the building, and after having performed said determination, operating one or more throttles according to said input and determination.

An embodiment of the invention will now be described, by way of example only, with reference to the accompanying drawings,

### BRIEF DESCRIPTION OF THE DRAWINGS

FIG. 1 shows a cross section of a double window comprising a frame and two panes of glass.

FIG. 2 shows details of the top frame of the window seen in FIG. 1.

FIG. 3 shows a cross section of an air direction control unit with two closed throttles.

FIG. 4 shows a cross section of an air direction control unit with a first throttle open.

FIG. 5 shows a cross section of an air direction control unit with a second throttle open.

FIG. 6 shows a cross section of a bypass unit with a closed throttle.

FIG. 7 shows a cross section of a bypass unit with an open throttle.

FIG. 8 shows an air direction control unit, a bypass unit and a drive unit arranged in a row.

FIG. 9 shows two throttles.

FIG. 10 shows details in a drive unit.

### DETAILED DESCRIPTION OF THE INVENTION

In the following text, the figures will be described one by one, and the different parts and positions seen in the figures will be numbered with the same numbers in the different figures. Not all parts and positions indicated in a specific figure will necessarily be discussed together with that figure.

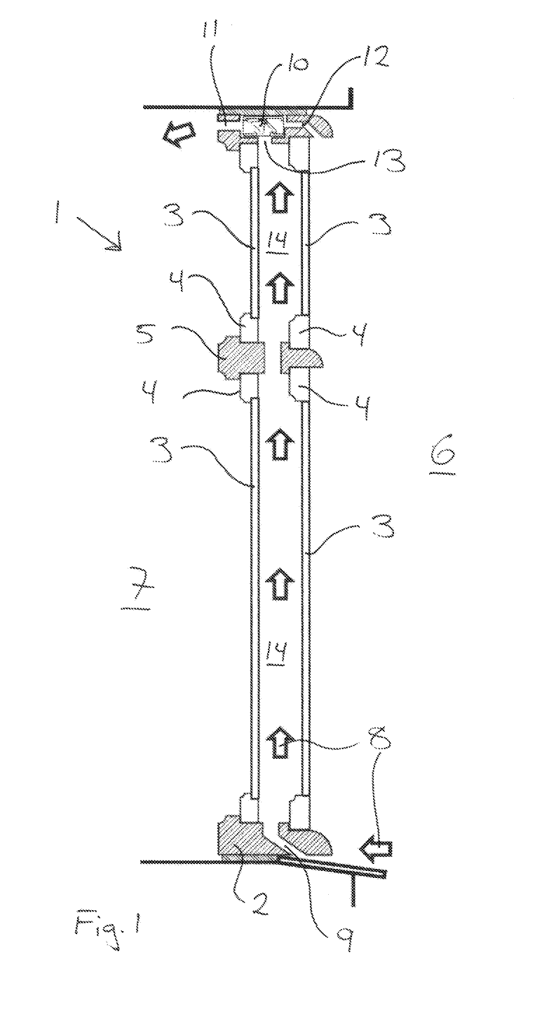

In FIG. 1 a cross section of a double window 1 comprising a frame 2 and four panes of glass 3, each installed in a casement or sash 4 is seen—two panes of glass 3 on each side installed in a common frame 2 and parted by a transom 5. One side of the window 1 is the exterior side 6 and the other is the interior side 7. In FIG. 1 ambient air/airflow—illustrated by arrows 8—is guided from the exterior 6 through an intake 9 in the bottom frame 2 and upwards between the panes of glass 3 and via an air direction control unit 10 in the top frame 2, said air 8 is guided to the interior 7. As can be seen in this figure, the top frame 2 comprises three openings 11, 12, 13, one towards the interior 7, another towards the exterior 6 and a third toward the air space 14 between the panes of glass 3. By operating the air direction control unit 10, air 8 can be directed in any of the two directions and the flow of air 8 can also be blocked.

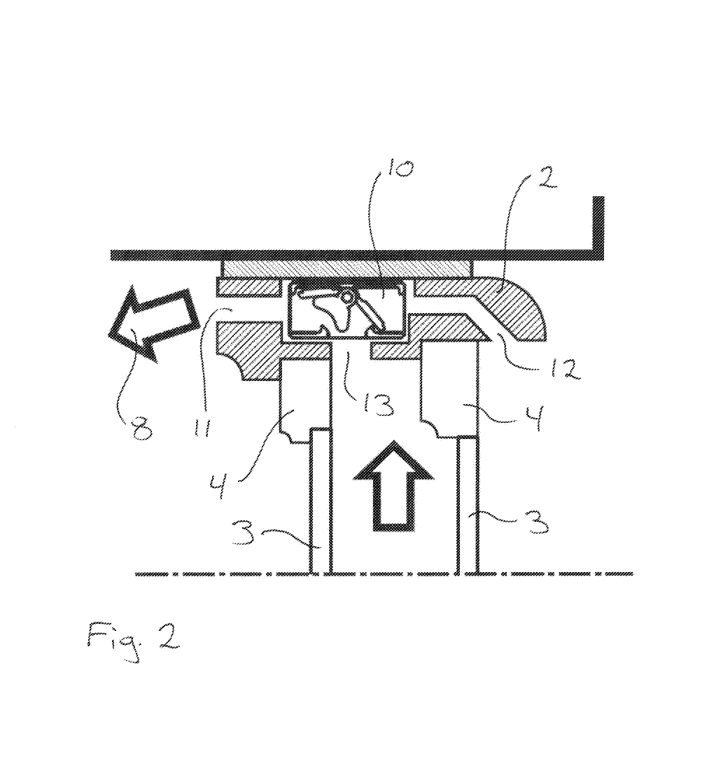

In FIG. 2, a close up of the air direction control unit 10 in the top frame 2 is seen.

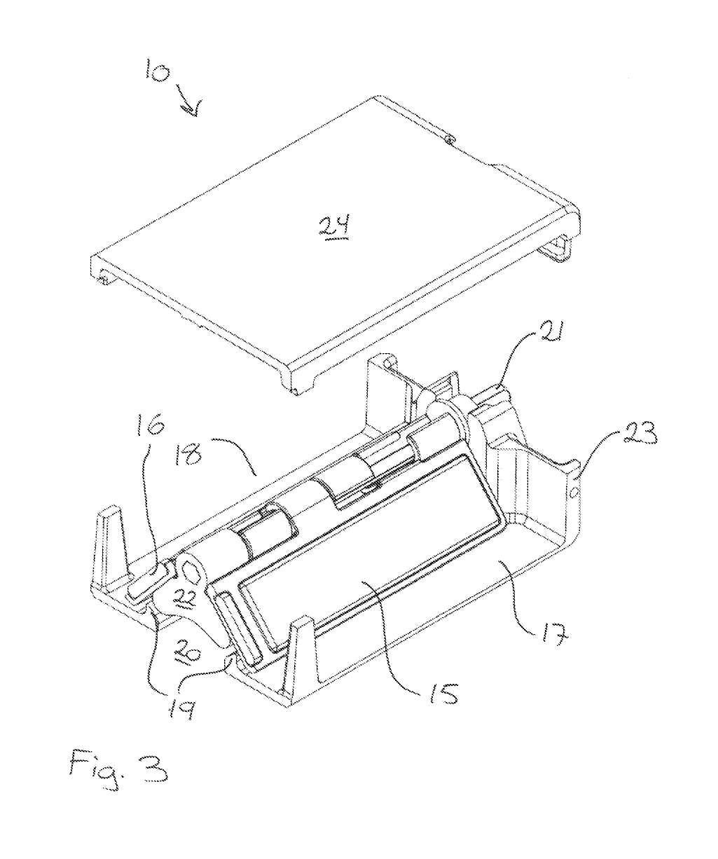

In FIG. 3, a cross section of an air direction control unit 10 is seen, where the first throttle 15 and the second throttle 16 are in a closed position and thus the first opening 17 and the second opening 18 in the air direction control unit 10 is closed. Said throttles 15, 16 are resting against a protrusion 19 along the third opening 20 that, when the air direction control unit 10 is installed in a window 1, is communicating with the air space 14 between the panes of glass 3. The throttles 15, 16 are arranged hinged on a hexagonal shaft 21 running in the longitudinal direction of the air direction control unit 10. On the shaft 21 there is a cam 22 that when the shaft 21 is rotated to either side will exert a push on one of the throttles 15, 16 and thus open said throttle 15, 16. The air direction control unit 10 comprises a body 23 and a lid 24, which in this figure and in some of the following is seen unassembled in order to show the throttles 15, 16, the shaft 21 and the cam 22.

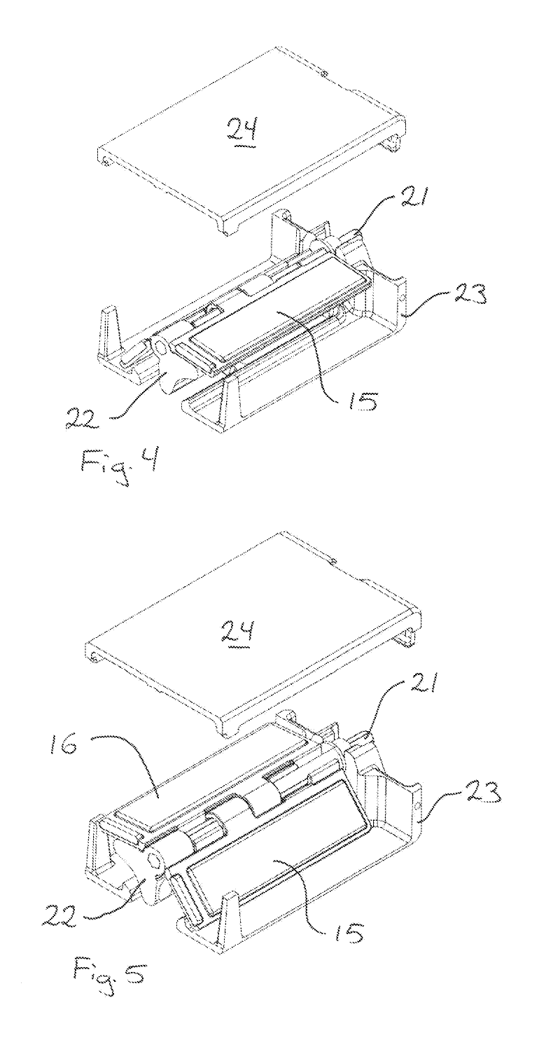

In FIGS. 4 and 5 the same parts as seen in FIG. 1 are displayed, but here with the respective first and second throttle 15, 16 in a closed and in an open position.

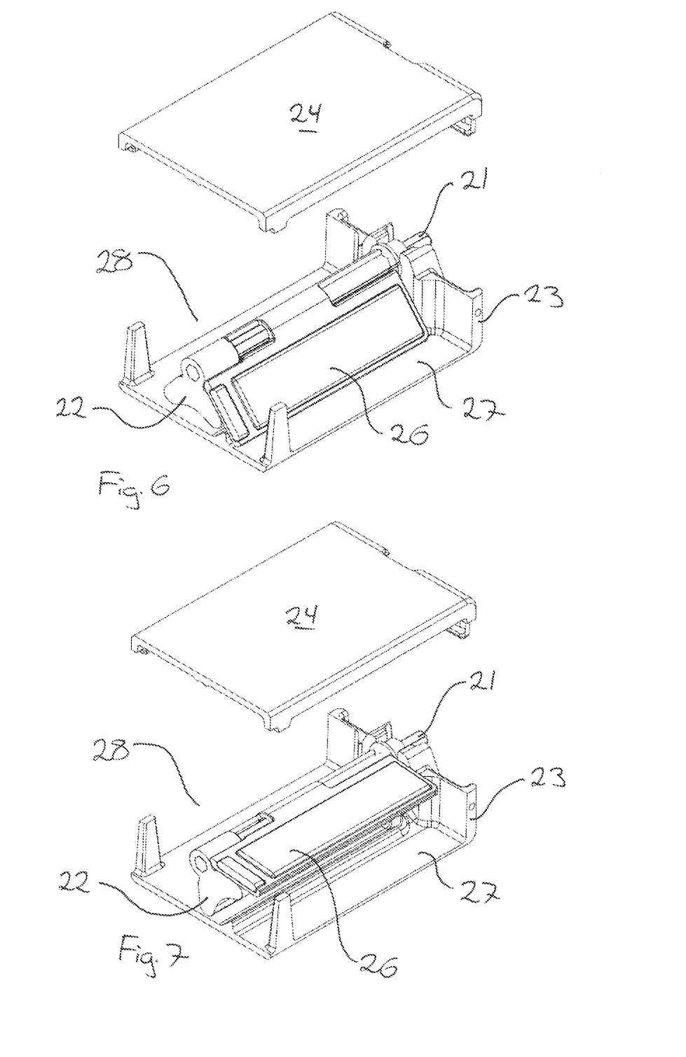

In FIGS. 6 and 7, a bypass unit 25 is seen, which in shape and appearance looks very much like an air direction control unit 10 as seen in FIGS. 3, 4 and 5. The main difference is that there is only one throttle 26 and there is no opening 20 towards the air space 14 between the window panes. This bypass unit 25 will when opened, as seen in FIG. 7, allow air 8 from one side 7, 8 of a window 1 to be exchanged with air 8 from the other side 7, 8 of a window 1. Also this bypass unit 25 is built with a shaft 21 and a cam 22 to activate the throttle 26 between a closed position as in FIG. 6 and an open position as in FIG. 7. The bypass unit 25 comprises a first opening 27 communicating with the interior 7, and a second opening 28 communicating with the exterior 6. The bypass unit 25 also comprises a body 23, having a lid 24 as the air direction control unit 10.

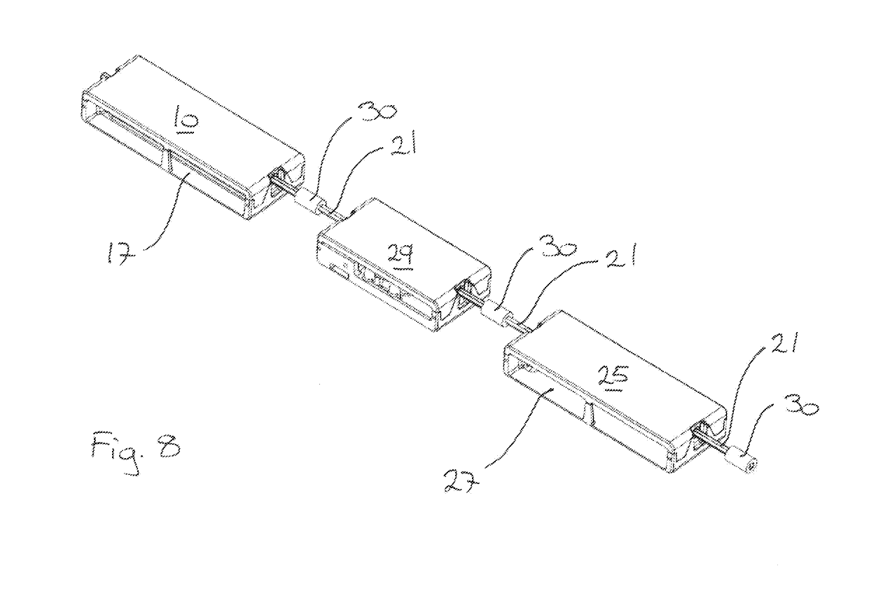

In FIG. 8, a row of three units 10, 25, 29 is seen. One air direction control unit 10, one drive unit 29 and one bypass unit 25. The shaft 21 of each of the units 10, 25, 29 is connected with the shaft 21 of the abutting unit 10, 25, 29 via a connection piece 30 with an inner hexagonal shape corresponding to the shape of the shaft 21. As it can be seen from this figure, all three units 10, 25, 29 have the same thickness and width, and only the length of the units vary. A typical set up of a ventilation device as disclosed in this text comprises at least one air direction control unit 10 and one bypass unit 25 and of course a drive unit 29. It is, however, possible to have more than one of each type of units 10, 25, 29 or to have none of one of the units 10, 25, 29. In a very simple solution, the drive unit 29 can actually be substituted by manual means for adjusting the position of the throttles 15, 16, 26 in the air direction control units and bypass units 10, 25.

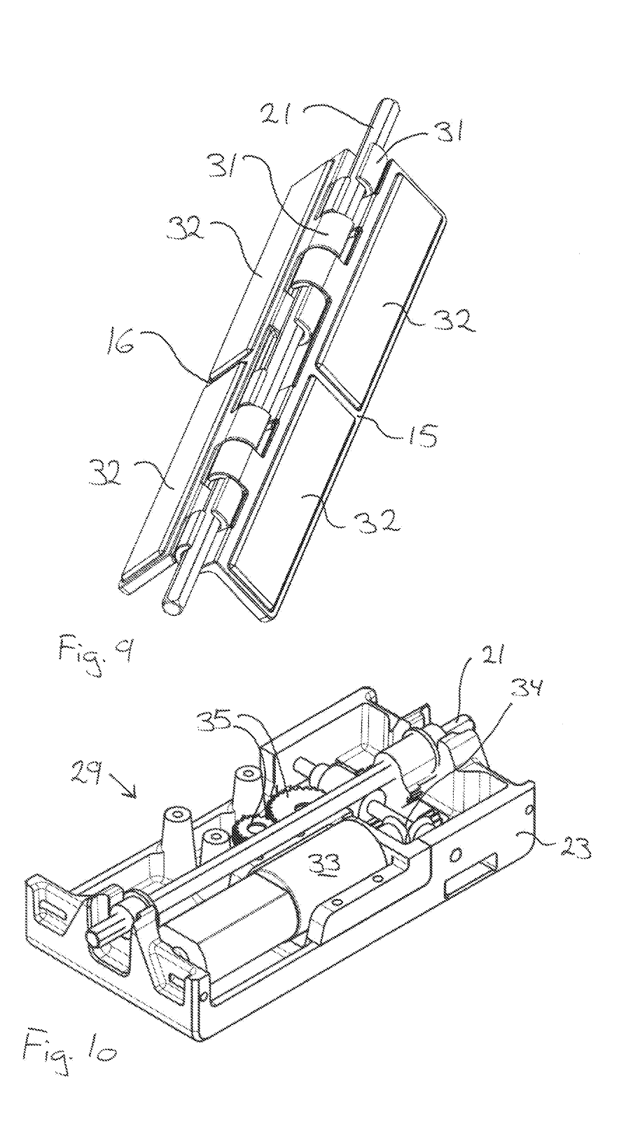

In FIG. 9, two throttles 15, 16 are seen on a hexagonal shaft 21. The throttles 15, 16 are alike and with fastening means 31—hinges—for coupling them to the shaft 21 in a manner that allows for the shaft 21 to be rotated in said hinges 31. Also a bypass unit 25 having only one throttle 26 can have said throttle 26 arranged on a shaft 21. There is simply only installed one throttle 26 on the shaft 21. Said bypass throttle 26 can also be manufactured like the throttles 15, 16 as used in an air direction control unit 10 in order to minimise the number of different parts needed. Further, the throttles 15, 16, 26 are fitted with weights 32, here in the shape of metal plates arranged on the outwardly surface of the throttles 15, 16, 26. This makes the closing of the throttles 15, 16, 26 easier and it secures a more tight closure. Further, the weights 32 prevent the throttles 15, 16, 26 to rattle due to the wind or other change of pressure on either side 6, 7 of the respective unit 10, 25.

In FIG. 10 an example of a drive unit 29 is seen without a lid 24. A lid 24 will have the general shape as seen in FIGS. 3-8. Inside the drive unit 29, an electrical actuator 33, a motor, is seen coupled to the shaft 21 via some gears 34. Further, a pair of gearwheels 35 is seen that interacts with not seen sensing means, in order to keep count of the position of the shaft 21 and the throttles 15, 16, 26.

The invention is not limited to the embodiments described herein, and may be modified or adapted without departing from the scope of the present invention.

What is claimed is:

1. A ventilation device for ventilating a room in a building, said building comprising a window, said window comprising at least two essentially parallel panes of glass, said at least two panes of glass being arranged in a common frame, casement or sash, hereinafter referred to as a frame, or in two or more juxtaposed and preferably connected frames, thus forming said window, e.g. a double window, where said at least two panes of glass are arranged with a distance, and thus appear with an air space between said panes of glass, said window further comprising an intake opening communicating with said air space and with either the interior or the exterior of said building, where said ventilation device comprises a drive unit, in which ventilation device comprises at least one air direction control unit, where said air direction control unit is arranged in connection with said window and where said air direction control unit comprises a body, having a first throttle and a second throttle, said air direction control unit further comprises means for operating said first and second throttle between an open and a closed position, further said body comprises a first opening communicating with the interior of said building, a second opening communicating with the exterior of said building and a third opening communicating with said air space, wherein said air direction control unit comprises a shaft, where said throttles are connected, hinged, to said shaft and wherein said first and second throttles, when closed, rest against a seat in the first and/or in the second opening in said body.

2. A ventilation device according to claim 1, wherein said ventilation device further comprises a bypass unit, where said bypass unit is arranged in said window and where said bypass unit comprises a body and a throttle, said bypass unit further comprises means for operating said throttle between a closed and an open position, further said body comprises a first opening communicating with the interior of said building, and a second opening communicating with the exterior of said building.

3. A ventilation device according to claim 2, wherein said bypass unit comprises a shaft, where said throttle is arranged, hinged, at said shaft and resting in a closed manner against a seat in the opening in said body.

4. A ventilation device according to claim 2, wherein said air direction control unit and/or bypass unit each further comprises a sealing material arranged between the throttle or each of the throttles and a seat for each of said throttles.

5. A ventilation device according to claim 2, wherein said air direction control unit and/or bypass unit each further comprises a weight material, arranged on each of said throttle or throttles.

6. A ventilation device according to claim 2, wherein the means for operating the throttles in the air direction control unit and/or the throttle in the bypass unit comprises one or more cams installed in each unit on said shaft, where rotation of said shaft in a specific direction will rotate said cam or cams to push against one or more specific throttles.

7. A ventilation device according to claim 2, wherein said shaft comprises means for connection to the drive unit, said drive unit further comprises or being connected to means for activating said one or more throttles between a closed position and an open position, said means e.g. being one or more cams installed on said shaft, where rotation of said shaft in a specific direction will rotate said cam or cams to push against one or more specific throttles.

8. A ventilation device according to claim 2, wherein air direction control unit and bypass unit or units comprises an insulating jacket for one or more individual units.

9. A ventilation device according to claim 1, wherein said ventilation device comprises control means for controlling and operating said drive unit, where said control means comprises at least one sensor.

10. A window for a building comprising a ventilation device according to claim 1, wherein said ventilation device is arranged in a window frame, casement or sash.

11. Method for operating a ventilation device for ventilating a room in a building, said building comprising a window, said window comprising at least two essentially parallel panes of glass, said at least two panes of glass being arranged in a common frame, casement or sash, or in two or more juxtaposed frames, thus forming said window, where said at least two panes of glass are arranged with a distance, and thus appear with an air space between said panes of glass, said window further comprising an intake opening communicating with said air space and with either the interior or the exterior of said building, where said ventilation device further comprises a drive unit, wherein that said method comprises at least the steps of:
detecting and computing input from at least one sensor, said input being based on actual conditions outside and/or inside said building and/or in said window or device,
determining by control means, based on said input, whether air should be led from the outside, through the air space and to the inside of the building,
determining by control means, based on said input, whether air should be led from the outside, through the air space and back to the outside of the building,
determining by control means, based on said input, whether air should be led from the outside and directly to the inside of the building or vice versa,
operating one or more throttles according to said input and determination.
